(19) United States
(12) Patent Application Publication
(10) Pub. No.: US 2007/0050509 A1
(43) Pub. Date: Mar. 1, 2007

(54) Device for managing the joining of parallel multimedia sessions to main multimedia sessions in a communication network

(75) Inventors: Jacques Litteaut, Marly Le Roi (FR); Stephane Coulon, Arronville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/502,526

(22) Filed: Aug. 11, 2006

(30) Foreign Application Priority Data
Aug. 17, 2005 (EP) 05300671.4

(51) Int. Cl. G06F 15/16

(52) U.S. Cl. 709/227

(57) ABSTRACT

A device (D) is dedicated to multimedia stream connection management (D) in an equipment (SS) of a communication network (R) involved in setting up communication sessions between communication terminals (T1-T4) connected to the network (R). This device (D) comprises management means (MG) adapted, when a main communication session is being set up that involves the equipment (SS) and is dedicated to a multimedia conference call between two or more internal communication terminals (T1-T3), on the one hand, to effect multimedia stream connections between the internal terminals (T1-T3) and, on the other hand, in the event of an attempt to set up a parallel call between a communication terminal (T4) external to the main session and one or more of the terminals (T1-T3) internal to the main session, to set up each parallel call between the external terminal (T4) and each of the requested internal terminals (T1-T3) so that the external terminal (T4) is able to exchange multimedia streams with one or more of the terminals (T1-T3) internal to the main session in the context of a parallel session.

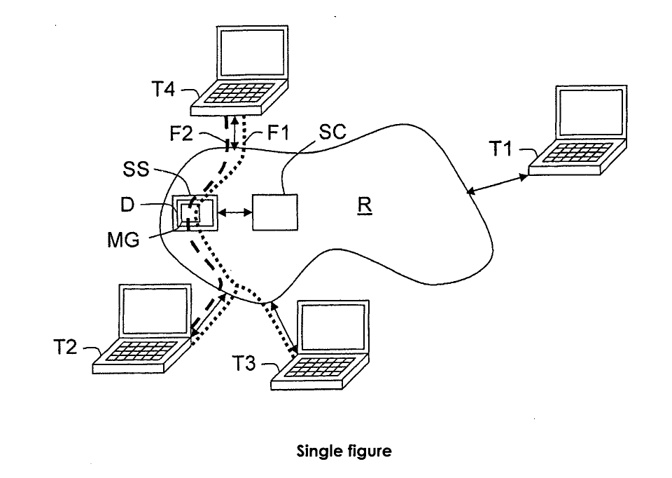

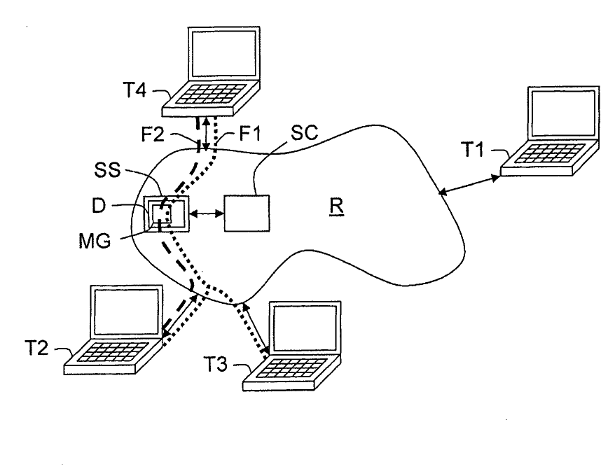

The field of the invention is that of communication networks and more precisely that of multimedia communication sessions between terminals connected to communication networks.

Technological advances in the field of communication networks, especially with regard to services, mean that communication terminals can now exchange multimedia (data) streams, including when they are conjointly participating in a session called a main session in the context of a multimedia conference call. Multimedia communication sessions in conference call mode are controlled by network equipments such as user session servers and conference servers, for example.

Operation in multimedia conference call mode is particularly advantageous because it enables users who are far apart to participate actively in a discussion, with the possibility of exchanging multimedia documents as if they were gathered together in the same place. However, the user of a terminal involved in a main session cannot be contacted on the same terminal by the user of another terminal external to the main session. It is therefore not possible for an external terminal to send multimedia data to one or more of the terminals participating in a main session or for the user of an external terminal to join in a conference call multimedia session once the conference call has begun.

The invention therefore has the object of removing some or all of these drawbacks.

To this end the invention proposes a multimedia stream connection management device for use in an equipment of a communication network involved in setting up communication sessions between communication terminals connected to the network.

The management device comprises management means adapted, when a main communication session is being set up that involves the network equipment and is dedicated to a multimedia conference call between two or more internal communication terminals, firstly, to effect multimedia stream connections between the internal terminals and, secondly, in the event of an attempt to set up a parallel call between a communication terminal external to the main session and one or more of the terminals internal to the main session, to set up each parallel call between the external terminal and each requested internal terminal so that the external terminal is able to exchange multimedia streams with one or more of the terminals internal to the main session in the context of a parallel session.

The management means of the device may also be adapted to effect a multimedia stream connection between the external terminal and one of the internal terminals so that the external terminal is able to assume at least partial control of the internal terminal.

The management means of the device may also be adapted to effect multimedia stream connections between the external terminal and one or more of the internal terminals so that they are able to share data representing multimedia documents via said parallel session.

The invention also proposes a communication network equipment adapted to participate in setting up communication sessions between communication terminals connected to the network, which network equipment comprises a management device of the type described above.

The equipment may take the form of a user session server or a conference server, for example.

Other features and advantages of the invention will become apparent on examining the following detailed description and the appended drawing, in which the single FIGURE shows in a highly schematic form four multimedia communication terminals connected to a network equipped with a conference server and a user session server comprising one embodiment of a management device of the invention. The appended drawing constitutes part of the description of the invention as well as contributing to the definition of the invention, if necessary.

One object of the invention is to enable a communication terminal external to a “main” multimedia session of a conference call in which communication terminals known as internal terminals are participating to exchange multimedia data with one or more of those internal terminals.

To this end, and as shown in the single figure, it proposes a multimedia stream connection management device D adapted to be installed in an equipment SS of a communication network R.

The equipment SS is one of the network equipments involved in setting up communication sessions in conference call mode between communication terminals Ti connected to their network R. Those network equipments comprise a conference server SC and the user session server SS, which are coupled to each other.

In the present nonlimiting example, the device D is installed in the user session server SS. However, it could instead be installed in the conference server SC. It is nevertheless important to note that in both cases the device D manages the conference call sessions and controls (monitors) the multimedia streams.

Moreover, in the example shown there are four terminals T1-T4 (i=1 to 4). However, i can take any value greater than or equal to three (3).

The communication terminals considered hereinafter by way of nonlimiting example are portable computers equipped with a multimedia communication module, where appropriate of the radio type (for example of the cellular, Bluetooth, WiMAX or WiFi type). However, the invention is not limited to that type of communication terminal. It relates to any fixed or mobile multimedia communication terminal capable of exchanging data in the form of signals with another communication terminal via their respective parent network(s). For example, the terminals could therefore be fixed or mobile telephones, fixed computers or personal digital assistants (PDA), equipped with a multimedia communication module.

The communication network considered hereinafter to which the terminals Ti are connected is a fixed switched network (the plain old telephone service (POTS) network or the public switched telephone network (PSTN)). However, the invention is not limited to that type of communication network. It relates to all types of network in which multimedia communications can be set up in conference call mode and in particular cellular (or mobile) networks, cable local area networks (LAN) and wireless local area networks (WLAN).

The management device D of the invention comprises a management module MG, also known as a multimedia conference session manager, that intervenes each time that a main communication session dedicated to a multimedia conference call between two or more internal communication terminals Ti is set up that involves the network equipment in which it is installed (here the user session server SS).

More precisely, the management module MG first sets up multimedia stream connections between the terminals internal to the main session that has been set up. It also identifies any terminal external to the main session seeking to set up a parallel call to one or more of the terminals internal to the main session and then, at the request of the external party whose terminal it has identified, sets up a parallel call between the identified external terminal and each internal terminal to which it has requested to be connected, in order for that external terminal to be able to exchange multimedia streams with one or more of the internal terminals in the context of a parallel multimedia session in conference call mode.

In other words, once it has set up a conference call main multimedia session, the management module MG sets up a parallel multimedia session between an external terminal and one or more terminals internal to the main session and then joins the main and parallel sessions.

To this end, the management module MG is active in the network R at three levels: the user session level (under the control of the user session server SS, in which it is installed in the present example), the network management level (which controls the setting up of the various media involved in the sessions), and the media connectivity level (under the control of the conference server SC).

The device D operates throughout the main session with which it is associated. It collates all events linked to the conference, for example the departure or the arrival of a participant. It manages all media and remains ready at all times to receive internal and external requests addressed to one or more of the internal participants and/or to the external terminal.

Two nonlimiting embodiments of the invention are described next. In the following two examples, the terminals T1 to T3 request the setting up of a conference call main multimedia session and the device D has been advised of this. The device D then sets up connections between the terminals T1 to T3, the user session server SS and the conference server SC. The terminals T1 to T3 can then exchange multimedia data streams in conference call mode (from here on they are referred to as internal terminals). Throughout the session, the device D watches for terminals external to the main session attempting to set up a call to one of the internal terminals T1 to T3. If this situation arises, the device D identifies the calling external terminal (this is the terminal T4 in the present example), each external terminal to which a connection is requested, and the subject of the call request(s).

The first example considers an external terminal T4 that wishes to send multimedia documents to two of the three internal terminals, for example the terminals T2 and T3 (this may be effected in the context of a parallel conference call between the terminals T2, T3 and T4). On receiving this request, the device D sets up two parallel calls between the external terminal T4 and the internal terminals T2 and T3 (dashed line arrow F1), for example, or a parallel conference session (it is preferable for the internal party or parties and the external party to be connected by way of a parallel (or secondary) conference call so that other internal parties can be added or removed dynamically). To this end, the device D operates at the level of the user session server SS and the conference server SC. When these parallel calls have been set up, or when the parallel conference call has been set up, the external terminal T4 can exchange multimedia streams with either or both of the internal terminals T2 and T3 without the terminal T1 being aware of this. The internal parties using the internal terminals T2 and T3 are able to monitor their media in order to select one of the conference calls at any time in order to be heard only by the terminals participating in the main (initial) or secondary (parallel) conference call that they have selected, for example by means of different voice frequencies, actuators (buttons or keypad keys) or icons that can be selected by means of a mouse.

In the second example, the external terminal T4 sends a request indicating that it wishes to intervene in the main conference call via one of the three internal terminals, for example the terminal T2. On receiving this request, the device D sets up a parallel call between the external terminal T4 and the internal terminal T2 (dashed line arrow F2). To this end it operates at the level of the user session server SS and the conference server SC. Note that in this case the parallel conference call is not restricted to the terminals T2 and T4, the external terminal T4 being added to the main conference call without taking the place of the internal terminal T2. The user of the external terminal T4 can therefore send a multimedia document to the internal terminal T2, which can then forward it to one or both of the other two internal terminals T1 and T3. Generally speaking, if they wish to do so, the terminals T1 to T4 can exchange multimedia documents via the parallel (or secondary) conference call. In other words, the four terminals T1 to T4 can share multimedia documents.

Many other situations may be envisaged, of course, for example a parallel or bidirectional multimedia conversation or listening (and only listening) to the external party.

The management device D may offer external parties an Internet (or “web”) type interface that offers them a choice of actions, for example as a function of the respective capacities and/or hierarchical positions of the parties. Among these actions there may be cited, for example, discrete listening to enable an external party to determine the status of a main conference call at any time, in order to intervene therein if necessary, or the transfer of a new external party into a main conference call by an authorized third party.

The management device D of the invention, and in particular its management module MG, may take the form of electronic circuits, software (or electronic data processing) modules or a combination of circuits and software.

The invention is not limited to the management device and network equipment embodiments described above by way of example only, and encompasses all variants that the person skilled in the art might envisage that fall within the scope of the following claims.

1. A multimedia stream connection management device for use in a network equipment of a communication network involved in setting up communication sessions between communication terminals connected to said network, which device comprises management means adapted, when a main communication session is being set up that involves said equipment and is dedicated to a multimedia conference call between two or more internal communication terminals, i) to effect multimedia stream connections between said internal terminals and ii) in the event of an attempt to set up a parallel call between a communication terminal external to said main session and one or more of said terminals internal to said main session, to set up a parallel call between said external terminal and the requested internal terminal or each requested internal terminal so that said external terminal is able to exchange multimedia streams with one or more of said terminals internal to said main session in the context of a parallel session.

2. A device as claimed in claim 1, wherein said management means are adapted to effect a multimedia stream connection between said external terminal and one of said internal terminals so that said external terminal is able to assume at least partial control of said internal terminal.

3. A device as claimed in either claim 1, wherein said management means are adapted to effect multimedia stream connections between said external terminal and one or more of said internal terminals so that they are able to share data representing multimedia documents via said parallel session.

4. A communication network equipment adapted to participate in setting up communication sessions between communication terminals connected to said network, which network equipment comprises a management device as claimed in claim 1.

5. A network equipment as claimed in claim 4, selected from a group comprising a user session server and a conference server.
